(19) United States
(12) Patent Application Publication
(10) Pub. No.: US 2019/0196710 A1
(43) Pub. Date: Jun. 27, 2019

(54) DISPLAY SCREEN PROCESSING METHOD AND SYSTEM

(71) Applicant: Lenovo (Beijing) Co., Ltd., Beijing (CN)

(72) Inventors: Xin JIANG, Beijing (CN); Juan David HINCAPIE-RAMOS, Beijing (CN)

(21) Appl. No.: 16/230,952

(22) Filed: Dec. 21, 2018

(30) Foreign Application Priority Data
Dec. 22, 2017 (CN) 201711403441.6

(51) Int. Cl. G06F 3/0488; G06F 3/01; G06F 9/451; G09G 5/14

(52) U.S. Cl. CPC G06F 3/04886; G09G 5/14; G06F 9/451; G06F 3/013

(57) ABSTRACT

The present disclosure provides a display screen processing method. Application scenario information of one or more virtual display screens displayed by a first electronic device through an optical lens module is determined. The first electronic device is coupled with a second electronic device that includes a physical display screen. A display parameter of the one or more virtual display screens is adjusted based on the application scenario information.

### CROSS-REFERENCES TO RELATED APPLICATIONS

This application claims the priority to Chinese Patent Application No. 201711403441.6, entitled “Display Screen Processing Method, First Electronic Device, and Second Electronic Device”, filed on Dec. 22, 2017, the entire content of which is incorporated herein by reference.

### FIELD OF THE DISCLOSURE

The present disclosure relates to the field of computer communication technologies and, more particularly, relates to a display screen processing method and system.

### BACKGROUND

Electronic devices may be equipped with physical display screens. However, display parameters of the existing physical display screens, e.g., a display form, cannot be changed. The disclosed methods and systems are directed to solve one or more problems set forth above and other problems.

### BRIEF SUMMARY OF THE DISCLOSURE

One aspect of the present disclosure provides a display screen processing method. Application scenario information of one or more virtual display screens displayed by a first electronic device may be determined. The first electronic device may be coupled with a second electronic device that includes a physical display screen. A display parameter of the one or more virtual display screens may be adjusted based on the application scenario information. The one or more virtual display screens may be configured to display one or more interfaces of the physical display screen.

Another aspect of the present disclosure provides a display system. The display system may include a first electronic coupled with a second electronic device that has a physical display screen. The first electronic device may include an optical lens module and a processor. The optical lens module may be configured to display one or more virtual display screens. The processor may be configured to determine application scenario information of the one or more virtual display screens based on the application scenario information. The one or more virtual display screens may be configured to display one or more interfaces of the physical display screen.

Other aspects of the present disclosure can be understood by a person skilled in the art in light of the description, the claims, and the drawings of the present disclosure.

Compared to the current technical solutions, the present disclosure provides a display screen processing method, in which a first electronic device may display one or more virtual display screens through an optical lens module. The first electronic device and a second electronic device may be connected. The second electronic device may have a physical display screen. The first electronic device may acquire and determine application scenario information of the virtual display screen and adjust a display parameter(s) of the virtual display screen based on the application scenario information. Now that the virtual display screen is not limited in a physical domain by any device and space, the display parameter(s) of the virtual display screen, such as a display shape, may be accordingly changed.

### BRIEF DESCRIPTION OF THE DRAWINGS

In order to more clearly explain embodiments and technical solutions of the present disclosure, the drawings in the description of the embodiments are briefly described below. Apparently, the drawings in the description are only some embodiments of the present disclosure. Other drawings may be obtained by a person of ordinary skill in the art based on the provided drawings without creative efforts.

FIG. 1 illustrates a schematic diagram of a display screen processing system according to some embodiments of the present disclosure;

FIG. 2 illustrates a flow diagram of a display screen processing method according to some embodiments of the present disclosure;

FIG. 3 illustrates a schematic diagram of acquiring a direction of a user's line of sight according to some embodiments of the present disclosure;

FIGS. 4A to 4L and FIGS. 5A to 5E each illustrates a schematic diagram of an application scenario according to some embodiments of the present disclosure;

FIG. 6 illustrates a flow diagram of a display screen processing method implemented to a second electronic device according to some embodiment of the present disclosure;

FIG. 7 is a structural diagram of a first electronic device according to some embodiments of the present disclosure;

FIG. 8 is a structural diagram of a second electronic device according to some embodiments of the present disclosure;

FIG. 9 is a structural diagram of another first electronic device according to some embodiments of the present disclosure; and

FIG. 10 is a structural diagram of another second electronic device according to some embodiments of the present disclosure.

### DETAILED DESCRIPTION

Technical solutions of embodiments of the present disclosure are described with reference to the accompanying drawings. Apparently, the described embodiments are merely some but not all of the embodiments of the present disclosure. Other embodiments may be obtained by a person of ordinary skill in the art based on the disclosed embodiments of the present disclosure without creative efforts, which shall fall within the protection scope of the present disclosure.

The display screen processing method provided in the embodiments of the present disclosure may be implemented on a first electronic device and/or a second electronic device or may be implemented on a system including the first electronic device and/or the second electronic device.

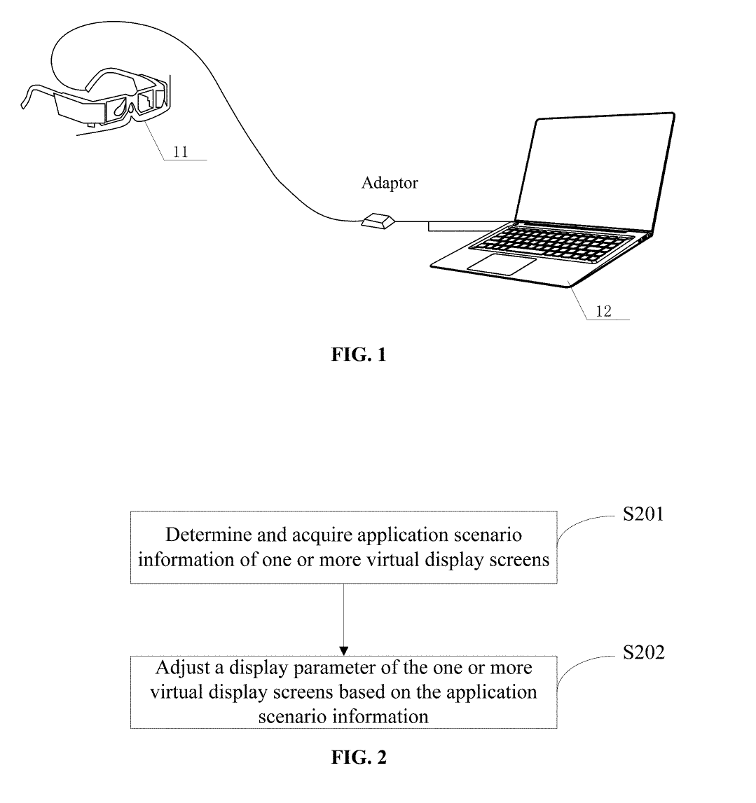

The first electronic device may include a wearable electronic device, such as a head-mounted display. The first electronic device may include a lens module which is an optical device. The optical lens module may be configured to display a virtual display screen (the number of virtual display screens may be one or more). The first electronic device and the second electronic device may be connected. The first electronic device and the second electronic device may be connected through an adaptor, a Bluetooth connection, or a WiFi connection, the connection manner of which is not limited in the embodiments of the present disclosure. FIG. 1 shows an example in which the first electronic device is connected with the second electronic device through an adaptor according to some embodiments of the present disclosure.

The second electronic device may be an electronic device such as a desktop, a mobile terminal (e.g., a smart phone, or a notebook), an iPad or the like. The second electronic device may include a physical display screen, and the virtual display screen displayed by the first electronic device may be configured to display one or more window interfaces in the physical display screen. That is, the virtual display screen may be recognized as an equivalence to an expansion screen of the physical display screen.

The display screen processing method provided in the embodiments of the present disclosure may be applied to various application scenarios. The embodiments of the present disclosure provide but are not limited to the following application scenarios.

In a first application scenario, the first electronic device may be configured to determine application scenario information of the virtual display screen and adjust a display parameter of the virtual display screen based on the application scenario information. In the first application scenario, the display screen processing method is completely implemented to the first electronic device.

In a second application scenario, a display screen processing system as shown in FIG. 1 may be used. The display screen processing system may include a first electronic device 11 and a second electronic device 12.

The second electronic device 12 may be configured to determine the application scenario information of the virtual display screen and send the application scenario information of the virtual display screen to the first electronic device 11. The first electronic device 11 may adjust the display parameter of the virtual display screen based on the application scenario information. In the second application scenario, the application scenario of the virtual display screen is acquired by the second electronic device 12.

In a third application scenario, the second electronic device 12 may be configured to determine second application scenario information of the virtual display screen and send the second application scenario information of the virtual display screen to the first electronic device 11. The first electronic device 11 itself may also determine first application scenario information of the virtual display screen. Accordingly, the first electronic device 11 may adjust the display parameter of the virtual display screen based on the first application scenario information and the second application scenario information. In the third application scenario, the second electronic device 12 and the first electronic device 11 can both determine the application scenario information of the virtual display screen.

In a fourth application scenario, the first electronic device 11 may determine the application scenario information of the virtual display screen displayed by the first electronic device 11 and send the application scenario information to the second electronic device 12. The second electronic device 12 may adjust the display parameter of the virtual display screen displayed by the first electronic device 11 based on the application scenario information of the virtual display screen.

The manner that the second electronic device 12 adjusts the first electronic device 11 may include the followings.

In some embodiments, the second electronic device 12 may acquire the display parameter based on the application scenario information of the virtual display screen and send the display parameter to the first electronic device 11, and the first electronic device 11 may display the virtual display screen according to the display parameter.

In some embodiments, the second electronic device 12 may obtain first instruction information for instructing the first electronic device 11 to adjust the display parameter of the virtual display screen based on the application scenario information and send the first instruction information to the first electronic device 11. In response to the first instruction information, the electronic device 11 may adjust the display parameter of the virtual display screen.

In the fourth application scenario, the application scenario information of the virtual display screen is completely acquired and determined by the first electronic device 11.

In a fifth application scenario, the first electronic device 11 may determine first application scenario information of the virtual display screen displayed by the first electronic device 11 and send the first application scenario information to the second electronic device 12. The second electronic device 12 may itself determine second application scenario information of the virtual display screen. The second electronic device 12 may adjust the display parameter of the virtual display screen based on the first application scenario information and the second application scenario information of the virtual display screen.

In the fifth application scenario, the first electronic device 11 and the second electronic device 12 can be both configured to determine the application scenario information of the virtual display screen. The second electronic device 12 may adjust the display parameter of the virtual display screen by both the first application scenario information and the second application scenario information.

The manner that the second electronic device 12 adjusts the display parameter of the virtual display screen based on the first application scenario information and the second application scenario information may be identical to that of the second electronic device 12 adjusting the first electronic device 11 described in the second application scenario, which is not be repeated herein.

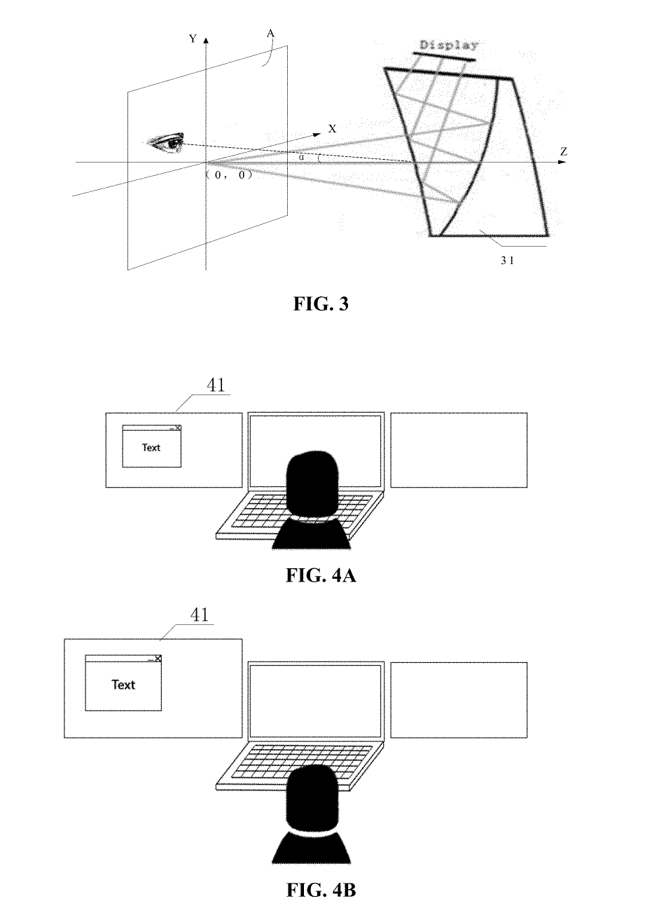

A display screen processing method implemented to the first electronic device according to some embodiments of the present disclosure is described below in view of the first application scenario, the second application scenario, and the third application scenario. As shown, FIG. 2 illustrates a flow diagram of a display screen processing method implemented to a first electronic device according to some embodiments of the present disclosure. The display screen processing method may include the followings.

In S201: The application scenario information of the virtual display screen may be acquired and determined.

The virtual display screen stated in S201 may generally refer to one or more virtual display screens displayed by the first electronic device. The manner for acquiring and determining the application scenario information of the virtual display screen may include but is not limited to: acquiring and determining user behavior information with respect to at least one virtual display screen of the one or more virtual display screens; and/or, acquiring and determining window interface information displayed by at least one virtual display screen of the one or more virtual display screens.

The number of the “at least one virtual display screen” may refer to one or more. In some embodiments, acquiring and determining the user behavior information with respect to the at least one virtual display screen of the one or more virtual display screens may further include: determining the at least one virtual display screen from the one or more virtual display screens. In some embodiments, acquiring and determining the window interface information displayed by at least one virtual display screen of the one or more virtual display screens may further include: determining the at least one virtual display screen from the one or more virtual display screens.

Various manners of determining the at least one virtual display screen from the one or more virtual display screens displayed by the first electronic device may be used.

For example, according to a first manner, from the one or more virtual display screens displayed by the first electronic device, a virtual display screen where a focus position corresponding to a direction of a user's line of sight is located may be determined.

The embodiments of the present disclosure also provide various manners for obtaining the direction of the user's line of sight. For example, in some embodiments, the first electronic device may be equipped with a near-infrared (NIR) sensor. When the user wears the first electronic device (such as a head-mounted electronic device), infrared light emitted by the NIR sensor may illuminate the user's eyes. At this time, iris of the user's eyes may reflect light generated by the infrared light. By detecting the reflected light through the NIR sensor, position parameters of the user's eyeballs may be determined, where the position parameters may include positions and directions of the eyeballs, and the direction of the user's line of sight may be obtained.

In some embodiments, the display screen processing method may further include: acquiring and determining a coordinate position of the user's eyeball on a first preset plane; and acquiring and determining an included angle between the user's eyeball and a first preset direction.

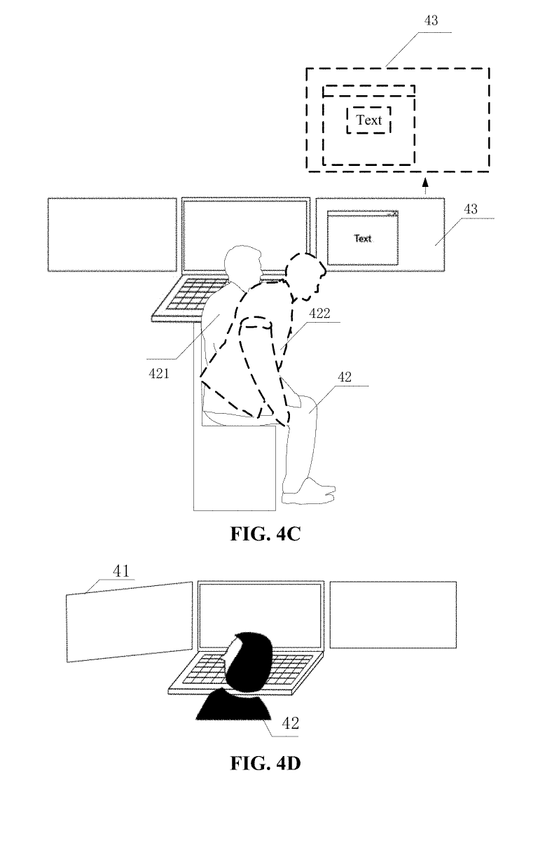

FIG. 3 is a schematic diagram of acquiring a direction of the user's line of sight according to some embodiments of the present disclosure. The first electronic device may include a MEMS sensor 31, and as shown in FIG. 3, the display screen as shown may include an NIR sensor. In some embodiments, the first preset plane may be pre-defined. For example, the first preset plane may be a plane “A” that is perpendicular to a reference light emitted by the first electronic device. In this case, an intersection of illumination light emitted by the first electronic device on the first preset plane may be defined as the coordinate origin (0, 0). A coordinate position of the user's eyeball on the first preset plane may be determined according to a projection position of the light reflected by the iris on the first preset plane detected by the NIR. For example, the position of the user's eyeball in FIG. 3 may be (−1, 1) in the second quadrant on plane ‘A’.

In some embodiments, the included angle between the user's eyeball and the first preset direction may also be obtained. The first preset direction may be defined as a direction of a reference light emitted by the first electronic device, such as a horizontal direction shown in FIG. 3. It can be seen from FIG. 3 that the included angle between the user's eyeball and the first preset direction is α.

It should be noted that the above definitions stated in the embodiments are only for illustrative purposes, and the present disclosure is not limited to the foregoing methods of defining the first preset direction and the manner for acquiring an eyeball position information of a user. For example, the plane on which the first electronic device presents a virtual scene may also be defined as the first preset plane, and based on this definition, a projection position of the user's eyeball on the first preset plane may be obtained.

A second manner for acquiring the direction of the user's line of sight may include: acquiring the direction of the user's line of sight by viewing angle tracking technology. By means of the viewing angle tracking technology to acquire the projection direction and the position parameter of the user's eyeball, a projection direction parameter may be further obtained.

In some embodiments, a position parameter of the optical lens module and a rotation angle of the optical lens module may be obtained by the viewing angle tracking technology.

The optical lens module may be configured to project light into the user's eyes so that the user can see the virtual display screen. As the direction of the user's line of sight changes, the rotation angle and the position of the optical lens module may also change. Therefore, the projection direction parameter can be obtained by the rotation angle and the position parameters of the optical lens module.

A third manner for acquiring the direction of the user's line of sight may include: acquiring the direction of the user's line of sight by Simultaneous Localization and Mapping (SLAM) algorithm.

By using the SLAM algorithm, the position of the physical display screen can be identified and detected in real time, and the position and the rotation angle of the optical lens module of the first electronic device can be acquired in real time.

A fourth manner for obtaining the direction of the user's line of sight may include: tracking the user's head movement, and information of the user's line of sight may be determined according to the user's head movement.

That is, the first electronic device may be an electronic device being worn on the user's head. In some embodiments, the first electronic device may be equipped with various movement detection sensors, such as an acceleration sensor. The movement detection sensors may be configured to detect the user's head movement through detecting a self-movement of the first electronic device. Based on a relative positional relationship between the user's head and the first electronic device, combining the detected movement information, the direction of the user's line of sight may be determined.

In some embodiments, the focus position corresponding to the user's line of sight may be switched among multiple virtual display screens. That is, the virtual display screen where the focus position corresponding to the direction of the user's line of sight is located may be different at a different moment.

In some embodiments, one or more virtual display screens displayed by the first electronic device 11 may be determined as the at least one virtual display screen.

The application scenario information corresponding to the at least one virtual display screen may be determined by the first electronic device. Alternatively, the application scenario information may be determined by the second electronic device and sent to the first electronic device. In some embodiments, after the second electronic device determines the user behavior information with respect to the at least one virtual display screen (or, the window interface information displayed by the at least one virtual display screen), the user behavior information with respect to the at least one virtual display screen (or, the window interface information displayed by the at least one virtual display screen) is sent to the first electronic device, and the first electronic device determines the window interface information displayed by the at least one virtual display screen (or, the user behavior information with respect to the at least one virtual display screen).

In S202: A display parameter of the virtual display screen may be adjusted based on the application scenario information.

The display parameter may include at least one of a display position, a display shape, and a display size of the virtual display screen. The display size may include a display area and/or a display resolution.

Some embodiments of the present disclosure provide a display screen processing method implemented to a first electronic device. The first electronic device may display one or more virtual display screens through an optical lens module. The first electronic device and a second electronic device may be connected. The second electronic device may have a physical display screen. The first electronic device may acquire and determine application scenario information of the virtual display screen and adjust a display parameter of the virtual display screen based on the application scenario information. Because the virtual display screen is not limited by the physical device or the space, the display parameter of the virtual display screen, such as a display shape, may be changed.

The manners as to how to adjust the display parameter(s) of the virtual display screen based on the application scenario information is described in detail below.

In parameter adjusting manner 1, if the application scenario information of the virtual display screen displayed by the first electronic device is distance change information of the user and the at least one virtual display screen, in some embodiments of the present disclosure, “adjusting the display parameter of the virtual display screen based on the application scenario information” may include: adjusting the display size of the at least one virtual display screen based on the distance change information of the user and the at least one virtual display screen.

One virtual display screen of the at least one virtual display screen is used as an example for the following description.

In some embodiments, the user approaches (moves towards) the virtual display screen, i.e., the distance between the user and the virtual display screen changes from a first distance to a second distance, and the first distance is greater than the second distance. In this case, the size of the virtual display screen may be reduced so that the user can see an entire virtual display screen. In another case, the user moves away from the virtual display screen, i.e., the distance between the user and the virtual display screen changes from a third distance to a fourth distance, and the third distance is less than the fourth distance. The size of the virtual display screen may be increased so that the user can clearly see the window interface displayed in the virtual display screen.

In some embodiments, during the process of increasing the size of the virtual display screen or reducing the size of the virtual display screen, the window interface displayed in the virtual display screen may be increased or decreased in proportion. That is, the adjustment of the virtual display screen is an overall adjustment. If the virtual display screen is adjusted as a whole, a display content displayed in the virtual display screen may be also enlarged or reduced as a whole to facilitate the user's viewing experiences.

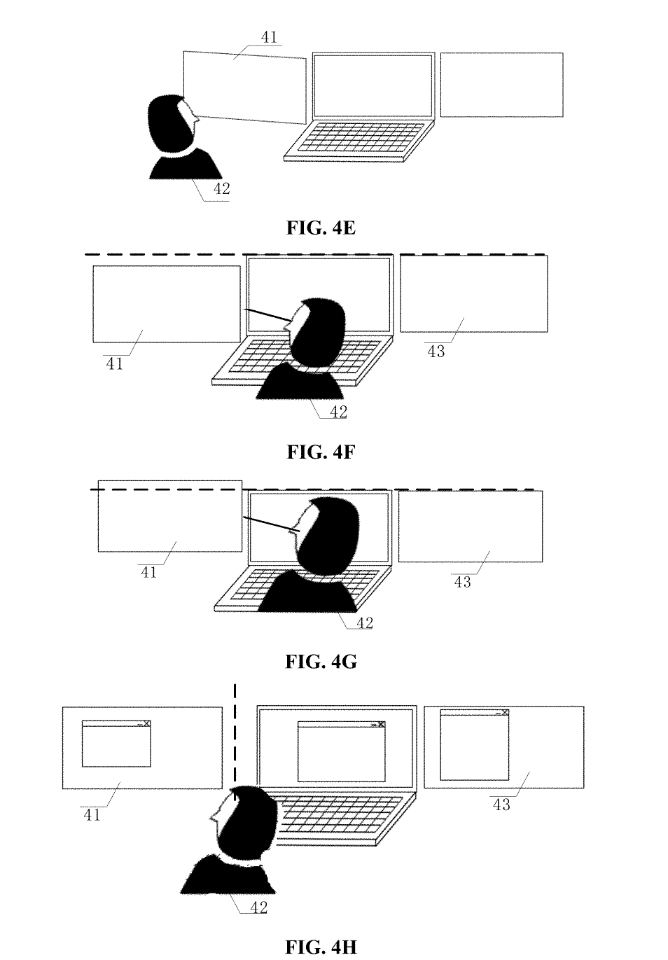

FIGS. 4A to 4B are schematic diagrams showing a variation of the display size of a virtual display screen according to some embodiments of the present disclosure, which illustrates a process of the user gradually moving away from the virtual display screen 41. As shown in FIG. 4A and FIG. 4B, the display size of the virtual display screen 41 in FIG. 4B is larger than the display size of the virtual display screen 41 in FIG. 4A.

In some other embodiments, while the user is moving away from a virtual display screen (herein referred to as the first virtual display screen), the user may be approaching another virtual display screen (herein referred to as the second virtual display screen). At this time, while the display size of the first virtual display screen is increasing, the display size of the second virtual display screen may be decreasing.

In some other embodiments, the user may approach the virtual display screen due to being unable to see the window interface displayed in the virtual display screen clearly. When the user cannot see clearly, the user may subconsciously perform actions of bending, blinking, etc., to adjust or attempt to adjust the distance from the virtual display screen. The display size of the virtual display screen may be increased if these actions of the user are captured. Therefore, based on the distance change information of the user and the at least one virtual display screen, adjusting the display size of the at least one virtual display screen may include: acquiring and determining an intention parameter that characterizes the user's intention corresponding to the at least one virtual display screen through the distance change information of the user and the at least one virtual display screen. The display size of the at least one virtual display screen may be adjusted based on the intent parameter corresponding to the at least one virtual display screen.

The information of the user's line of sight may also include information of the user's squinting or blinking. The information of the user's squinting or blinking may reflect user's current visual clarity of seeing the virtual display screen, and it may also reflect the user's current visual fatigue level. In some embodiments of the present disclosure, according to the information of the user's squinting or blinking, the display size of the virtual display screen may be dynamically adjusted, a display color or a background color may be switched to an eye protection mode, or a display brightness may be dynamically adjusted, so as to effect various intelligent dynamic display of the virtual display screen. Obtaining the information of the user's line of sight in the embodiment of the present disclosure may be determined through image collection and/or analysis of the first electronic device, or may be obtained through image acquisition and/or analysis of a camera connected to the first electronic device.

In parameter adjusting manner 2: If the application scenario information corresponding to the at least one virtual display screen is a projection position of the user's line of sight corresponding to the at least one virtual display screen, adjusting the display parameter of the virtual display screen based on the application scenario information may include: dynamically adjusting a position of the at least one virtual display screen in a horizontal direction and/or a vertical position based on the projection position of the user's line of sight.

FIG. 4C is a schematic diagram showing another variation of the display size of a virtual display screen according to some embodiments of the present disclosure.

A position of the seat of the user 42 in FIG. 4C is not changed, but the body of the user 42 is tilted toward the virtual display screen 43 with a direction from a solid line 421 to a dotted line 422, that is, approaching the virtual display screen 43. At this time, the display size of the virtual display screen 43 increases and turns into the virtual display screen 43 indicated by the dotted line pointed by an arrow.

For a user with hyperopia viewing the window interface displayed in the virtual display screen, if it is considered that the display of the window interface is too large so that the user cannot see clearly, the user may actively move away from the virtual display screen. If the user cannot see clearly, the user might subconsciously adjust or attempt to adjust the distance from the virtual display screen by moving back, blinking, or the like. If such an action is captured from the user, the display size of the virtual display screen can be accordingly reduced.

In some embodiments, during the process of increasing the size of the virtual display screen or reducing the size of the virtual display screen, the window interface displayed in the virtual display screen may increase or decrease in proportion. That is, the adjustment of the virtual display screen is an overall adjustment. If the virtual display screen is adjusted as a whole, the display content displayed in the virtual display screen is also enlarged or reduced as a whole to facilitate the user's viewing experiences.

In parameter adjusting manner 3: If the application scenario information corresponding to the at least one virtual display screen is a direction of the user's line of sight corresponding to the at least one virtual display screen, adjusting the display parameter of the virtual window based on the application scenario information may include: dynamically adjusting an orientation of the at least one virtual display screen based on the user's line of sight, such that the orientation of the at least one virtual display screen changes following the change of the direction of the user's line of sight.

One virtual display screen of the at least one virtual display screen is taken as an example for the following description.

In some embodiments, the at least one virtual display screen is a virtual display screen where the focus position corresponding to the direction of the user's line of sight is located. For example, if the user's line of sight is in the southeast direction, the virtual display screen may be oriented in the northwest direction. If the user looks upwards, for example, lying down to watch the video, the direction of the user's line of sight is from bottom to top, and the virtual lower screen may be oriented downwards. That is, the user's line of sight may face the virtual display screen. In some embodiments, the user's head corresponds to a center position of the virtual display screen to facilitate the user to view the virtual display screen. FIGS. 4D to 4E are schematic diagrams of an orientation change of a virtual display screen according to some embodiments of the present disclosure.

FIG. 4D shows that a focus position corresponding to the direction of the line of sight of the user 42 is on the virtual display screen 41. If the user views the virtual display screen 41 to the left, the virtual display screen 41 may face rightward so that the direction of the user's line of sight directly faces the virtual display screen 41 to facilitate the user to view the virtual display screen 41. In FIG. 4E, if the direction of the line of sight of the user 42 is to the right, the virtual display screen 41 may face leftward, so that the direction of the user's line of sight exactly faces the virtual display screen 41 to facilitate the user to view the virtual display screen 41.

Thus, if the user turns the head, the orientation of the user's line of sight changes, and the orientation of the virtual display screen also dynamically changes. Images of the virtual display screen may rotate in the user's locating space as the user turns the head. In some embodiments, the orientation of the virtual display screen is dynamically adjusted by the direction of the user's line of sight. The virtual display screen dynamically tracks the user's line of sight, so that the virtual display screen may be always displayed within a visible range of the user. As such, the user is not required to look around for finding the virtual display screen that the user intends to see when needed.

Referring to FIGS. 4F to 4H, the virtual display screen 43 in FIG. 4F is in a default position. Assuming that the user's line of sight corresponds to the focus position on the virtual display screen 41, a display position of the virtual display screen 41 may be moved down if the user's line of sight shifts downward. The position of the dotted line in FIG. 4F shows the position where the upper edge of the virtual display screen 41 is aligned before the virtual display screen 41 being moved downward.

In FIG. 4G, the projection position of the user's line of sight moves upward. For example, if the user stands up and views the virtual display screen 41, the display position of the virtual display screen 41 moves upward. In FIG. 4G, the position of the dotted line shows where the upper edge of the virtual display screen 41 is aligned before the virtual display screen 41 is moved upward.

In FIG. 4H, the projection position of the user's line of sight moves to the left. For example, if the user moves to the left, the display position of the virtual display screen 41 is shifted to the left. The position of the dotted line in FIG. 4H shows where the right edge of the virtual display screen 41 is aligned before the virtual display screen 41 being shifted to the left.

In parameter adjusting manner 4: If the application scenario information corresponding to the at least one virtual display screen is the distance change information of the user and the at least one virtual display screen, adjusting the display parameter of the virtual display screen may include: dynamically adjusting a bending form of the at least one virtual display screen based on the distance change information of the user and the at least one virtual display screen.

Based on the distance change information of the user and the virtual display screen, the virtual display screen is adjusted to a curved screen. That is, the bending form of the virtual display screen may be adjusted based on the distance change information of the user and the virtual display screen. The bending form herein may refer to a shape form of the virtual display screen that is forced from a flat form into a curved form.

In some embodiments, dynamically adjusting the bending form of the at least one virtual display screen based on the distance change information of the user and the at least one virtual display screen respectively may include the followings.

With respect to each virtual display screen, at least one row of pixels may be obtained from the virtual display screen, each row of pixels being parallel to a horizontal plane.

With each row of pixels, a bending form of the row may be adjusted so that a distance between each pixel of the row and the user is equal and a corresponding bending form of the at least one row of pixels may be obtained, thereby achieving the bending form of the at least one display screen.

For example, FIG. 4I shows a cross-sectional view of a physical display screen and a virtual display screen according to some embodiments of the present disclosure. Assuming that the user's line of sight corresponding to the focus position is on the virtual display screen 41, FIG. 4I shows a cross-sectional view of the virtual display screen 41 after bending, a cross-sectional view of the physical display screen 40, and a cross-sectional view of the virtual display screen 43. In the cross-sectional views, it can be seen that the cross-section of the virtual display screen 41 may be a part of a circle (or an arc), and the position of the user, e.g., the user's head or the user's eyeball, is located at a center of the circle corresponding to the arc.

FIG. 4J shows another cross-sectional view of a physical display screen and a virtual display screen according to some embodiments of the present disclosure.

As shown in FIG. 4J, the distance between the user and the virtual display screen 41 is greater than the distance between the user and the virtual display screen 41 in FIG. 4I. Accordingly, a bending degree of the virtual display screen 41 in FIG. 4J is smaller than that of the virtual display screen 41 in FIG. 4I. However, it can be seen that the cross section of the virtual display screen 41 may be a part of a circle (or an arc), and the user's position, e.g., the user's head or the user's eyeball, is located at a center of the circle corresponding to the arc.

Thus, a bending curvature of the virtual display screen 41 may be automatically adjusted according to the distance between the user and the virtual display screen, so as to ensure that the user's head is always at the center of the circle corresponding to the arc formed by each cross section of the virtual display screen 41. That is, the distance from each point on the arc formed by the cross section of the virtual display screen 41 to the user's head is equal. Since the distance between the user and the virtual display screen 41 in FIG. 4J is greater than that in FIG. 4I, the curvature of the cross section of the virtual display screen 41 in FIG. 4J is smaller than the curvature of the cross section of the virtual display screen 41 in FIG. 4I.

The virtual display screen 42 may have a plurality of cross sections parallel to a horizontal plane, one cross section corresponding to a row of pixels. With respect to any cross section, each point formed on the arc of the cross section to the user's head may be equal.

In parameter adjusting manner 5: If the application scenario information is a window interface displayed in the first virtual display screen of the at least one virtual display screen, adjusting the display parameter of the virtual display screen based on the application scenario information may include: acquiring window interface information displayed by a first virtual display screen of the at least one virtual display screen; and adjusting the first virtual display screen to be a flat screen or a curved screen based on the displayed window interface information.

The first electronic device 11 or the second electronic device 12 may identify an application type of the window interface displayed by the virtual display screen. The window interface information may be the application type to which the window interface belongs. In some embodiments, if the application type of the window interface displayed in the virtual display screen belongs to an entertainment application, since the curved screen can improve the immersion of the user in entertainment applications, such as a game or a movie, the virtual display screen may be configured as a curved screen. If the application displayed by the virtual display screen belongs to an application that the user does not desire to be deformed, for example, an application requiring a high-precision work class, for example, CAD, the virtual display screen may be configured as a flat screen.

The method for configuring the virtual display screen as a curved screen can be referred to parameter adjusting manner 4, and details are not described herein.

As shown in FIG. 4K, the application program of the window interface displayed in the virtual display screen 43 is an entertainment application program, and the virtual display screen 43 may be configured as a curved screen. As shown in FIG. 4L, the application program of the window interface displayed in the virtual display screen 43 is an application program that requires a high level of precision, and the virtual display screen 43 may be configured as a flat screen.

FIGS. 4A to 4L, according to the embodiments of the present disclosure, are only examples, and do not limit the number and/or the display position of the virtual display screen displayed by the first electronic device through the optical lens module. For example, the number of the virtual display screens displayed by the first electronic device through the optical lens module can be one, two, three, four, five, six, seven, eight, or other numbers. The position of the virtual display screen displayed by the first electronic device through the optical lens module may be on the left side of the physical display screen, the right side, the upper side, and/or the lower side.

Further, the five implementation manners described above can be used as a single implementation manner, or as a combination of any two implementation manners, any three implementation manners, any four implementation manners, or all five implementation manners.

For example, the first implementation manner and the second implementation manner may be combined.

The display size, the bending form, and the orientation of the virtual display screen may be dynamically adjusted based on the distance change information of the user and the virtual display screen and the direction of the user's line of sight. For example, the distance between the user and the virtual display screen is from the near to the far, and the direction of the user's line of sight is toward the left. In this case, the display size of the virtual display screen may be increased, the virtual display screen may be configured as a curved screen, and the orientation of the virtual display screen may be adjusted toward the right. Other combinations are similar and not repeated herein.

It can be understood that, in practical applications, the distance between the user and the virtual display screen, the direction of the user's line of sight, the projection position of the user's line of sight, and the window interface displayed in the virtual display screen may have dynamic changes. Assuming that the distance between the user and the virtual display screen is changed from small to large, the direction of the user's line of sight is to the right, the projection position of the user's line of sight moves up, and the window interface displayed in the virtual display screen belongs to an entertainment application, the display size of the virtual display screen may accordingly become larger, the virtual display screen may be a bent form, the display position of the virtual display screen may be moved up, and the virtual display screen may face to the left.

In practical applications, the first electronic device may display a plurality of virtual display screens through the optical lens module. If the second electronic device is in a screen saver state or in an off-screen state, no window interface may be displayed in the physical display screen. At this time, the focus position corresponding to the direction of user's line of sight may be on the virtual display screen. In some embodiments, the display positions of at least two virtual display screens may be moved so that the at least two virtual display screens are combined together.

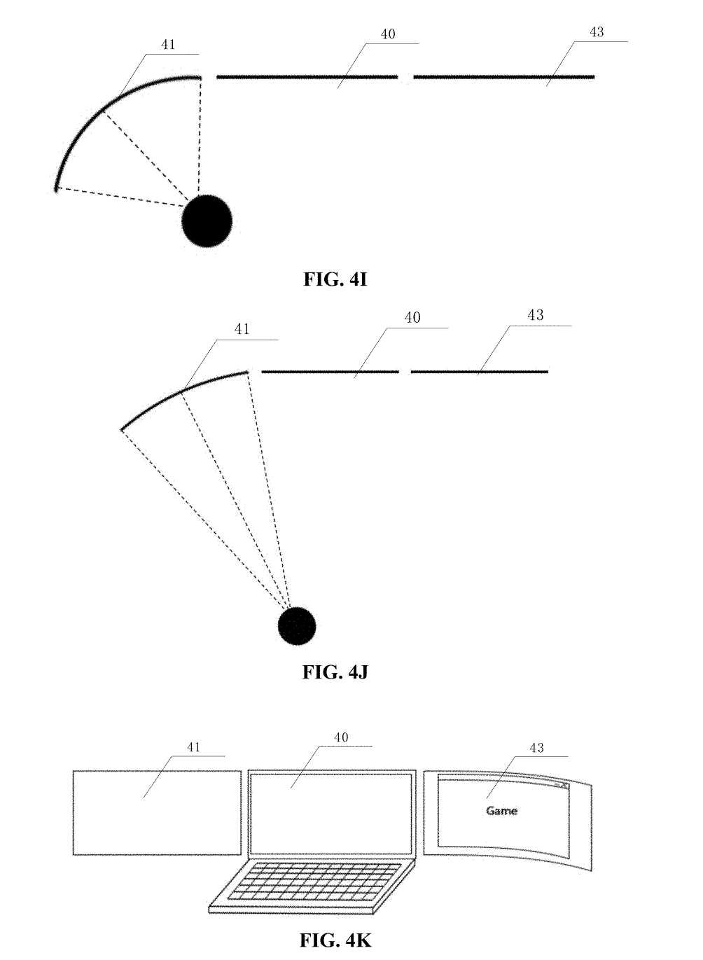

FIGS. 5a to 5B show schematic diagrams of a plurality of virtual display screens after being combined according to some embodiments of the present disclosure. FIGS. 5A to 5B also show a second electronic device coupled with the plurality of virtual display screens.

After a plurality of virtual display screens, for example, the virtual display screen 41 and the virtual display screen 43, are combined, the plurality of virtual display screens may be used as independent virtual display screens, respectively, or as a single integrated display screen.

As an explanation example, the second electronic device may refer to a notebook computer in the embodiments shown in FIG. 5A and FIG. 5B. As shown in FIG. 5A to FIG. 5B, the physical display screen 40 of the notebook computer is combined with a physical keyboard and closed, so that the notebook computer is in the screen saver state or the off-screen state.

FIG. 5A shows a state after the virtual display screen 41 and the virtual display screen 43 are combined. FIG. 5B shows the first electronic device displaying six virtual display screens through the optical lens module, and the six virtual display screens are combined together.

As shown in FIG. 5A to FIG. 5B, after the plurality of virtual display screens are combined, the plurality of virtual display screens can also be used as independent virtual display screens, respectively, or as a single integrated display screen.

For example, after the virtual display screens are combined, each virtual display screen is still used as an independent virtual display screen. The virtual display screen 51 in FIG. 5B may be configured to display a first window interface, the virtual display screen 52 may be configured to display a second window interface, and the virtual display screen 53 may be configured to display a third window interface.

Under normal circumstances, if the user's eyes need to be switched on a plurality of virtual display screens and if display resolutions of the plurality of virtual display screens are inconsistent, it may cause insufficient display sharpness when switching from a virtual display screen with a high resolution to another with a low resolution, or large display sharpness when switching from a virtual display screen with a low resolution to another with a high resolution, resulting in fatigue of the user's eyes. Therefore, in some embodiments, the virtual display screens may have a same display resolution.

In some embodiments, if the physical display screen is in a screen saver state or in an off-screen state, at least two virtual display screens may be combined to form a combined display screen.

The at least two virtual display screens may be combined to form an overall combined display screen. The combined display screen may be configured as a whole to display at least one window interface. As shown in FIG. 5C, the combined display screen 54 is formed by combining six virtual display screens. The combined display screen 54 may be configured to display a window interface 541 as a single combined display screen.

The combined display screen may also be adjusted to a curved screen. The specific manner is substantially identical to the above manners for adjusting a bending form of a single virtual display screen, details of which are not described herein. For example, with respect to a combined display screen, at least one row of pixels may be obtained from the combined display screen, and each row of pixels may be parallel to a horizontal plane. With respect to each row of pixels, a bending form of the row may be adjusted so that a distance between each pixel in the row and the user is equal, thereby obtaining a corresponding bending form of the at least one row of pixels and achieving a being form corresponding to the combined display screen.

In practical applications, the first electronic device may be configured to display a plurality of virtual display screens through the optical lens module. If the second electronic device is in an on-screen state, in some embodiments, the display position of the at least one virtual display screen may be moved, so that the at least one virtual display screen is combined together with the physical display screen to form a combined display screen.

After the at least one the virtual display screen and the physical display screen are combined to form an overall combined display screen, in some embodiments, both the virtual display screen and the physical display screen included in the combined display screen may function as independent display screens, such that the displayed window interfaces shown in FIG. 5D do not be interfered with each other. FIG. 5D illustrates a window interface of the physical display screen 40. As shown in FIG. 5D, the virtual display screen 54 and the virtual display screen 55, respectively, may be configured to display other window interfaces without any mutual interference with each other.

In some embodiments, the combined display screen may be configured to display at least one window interface as a whole display screen. As shown in FIG. 5E, the combined display screen 56 combines five virtual display screens and a physical display screen. The combined display screen 56 may be used as a whole to display a window interface as shown in FIG. 5E.

It can be understood that the physical display screen may be a curved screen or a flat screen. If the physical screen is a curved screen, in consideration of visual effects, the combined display screen may be an integral display screen. As such, the combined display screen may be adjusted as a curved screen. If the physical display screen is a flat screen, again in view of the visual effect, the combined display screen may be an integral display screen. Therefore, the combined display screen may be adjusted as a flat screen.

It can be understood that the bending form of the physical display screen is fixed and cannot be changed. However, the adjustment of the bending form of the combined display screen may still be related to the bending form of the physical display screen and the position of the physical display screen in the combined display screen.

In some embodiments, if the physical display screen is a curved screen, adjusting the combined display screen as a curved screen may include the following. For example, if the physical display screen is a curved screen, the position of the physical display screen in the combined display screen may be first identified. Based on the identified position of the physical display screen in the combined display screen and the bending form of the physical display screen, a bending form of the combined display screen may be determined.

Assuming that the physical display screen is located at a lower left position of the combined display screen, by taking FIG. 5E as an example, the virtual display screen 58 may have a same bending form as the physical display screen 40, the virtual display screen 57 may have a same bending form as the virtual display screen 54, and the virtual display screen 55 may have a same bending form as the physical display screen 59.

The manner for adjusting the bending form of the combined display screen is identical to the manner for adjusting the bending form of a single virtual display screen, which is not described herein. For example, with respect to a combined display screen, at least one row of pixels may be obtained from the combined display screen, and each row of pixels may be parallel to a horizontal plane.

With respect to each row of pixels, a bending form of the row may be adjusted so that the distance between each pixel of the row and the user is equal, thereby obtaining a bending form corresponding to the at least one row of pixels and thus achieving a bending form corresponding to the combined display screen.

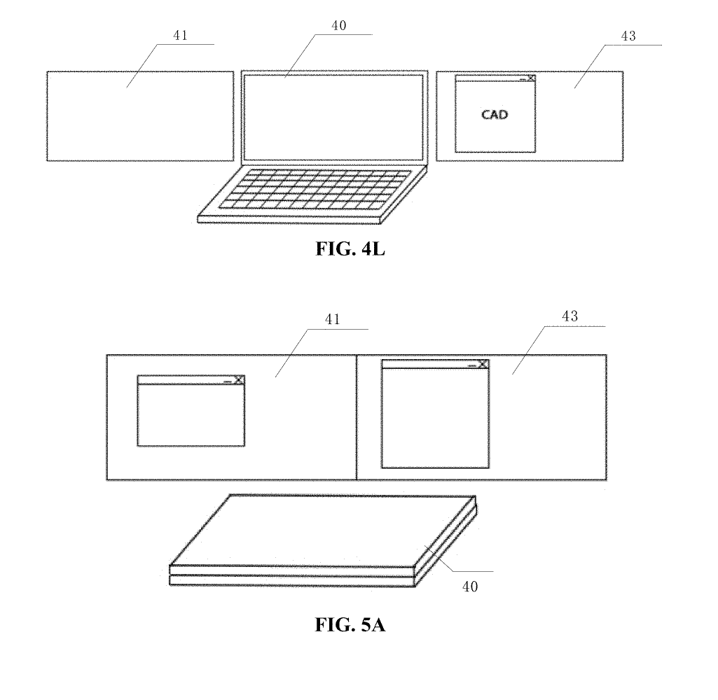

The below describes a display processing method implemented to the second electronic device combining the fourth application scenario and the fifth application scenario. FIG. 6 shows a flow diagram of the display processing method implemented to the second electronic device according to some embodiments of the present disclosure. The method may include the following.

In S601: The application scenario information of the virtual display screen displayed by the first electronic device through the optical lens module may be obtained.

The number of the virtual display screens displayed by the first electronic device through the optical lens module may be one or more. In some embodiments, the application scenario information of the virtual display screen obtained by the first electronic device may include, but is not limited to, the user behavior information with respect to the at least one virtual display screen in the virtual display screens, and/or the window interface information displayed by at least one virtual display screen of the virtual display screens.

In S602: A display parameter of the virtual display screen in the first electronic device may be adjusted based on the application scenario information.

In S602, the second electronic device 12 may be configured to adjust the display parameter(s) of the virtual display screen in the first electronic device entirely based on the application scenario information of the virtual display screen obtained from the first electronic device.

In some embodiments, the second electronic device 12 may also obtain the application scenario information of the virtual display screen. At this time, S602 may include adjusting the display parameter(s) of the virtual display screen in the first electronic device based on the application scenario information of the virtual display screen obtained by the first electronic device and the application scenario information of the virtual display screen determined by the second electronic device.

The method for obtaining the application scenario information of the virtual display screen by the second electronic device is identical to the method for obtaining the application scenario information of the virtue display screen by the first electronic device, and the description may be obtained from the description of obtaining the application scenario information of the virtual display screen by the first electronic device. The details are not described herein again.

In some embodiments, S602 may be implemented in many manners as the following.

In Manner one: Based on the application scenario information, first instruction information may be generated. The first instruction information may be used to instruct the first electronic device to adjust the display parameter of the virtual display screen. The first instruction information may be sent to the first electronic device.

If the application scenario information of the virtual display screen is the user behavior information with respect to at least one virtual display screen of the virtual display screens, generating the first instruction information based on the application scenario information may include at least one of the following.

In some embodiments, based on the distance change information of the user and the at least one virtual display screen, the first instruction information for adjusting the display size of the at least one virtual display screen, and/or dynamically adjusting the bending form of the at least one virtual display screen may be generated.

In some embodiments, based on the direction of the user's line of sight, the first instruction information for dynamically adjusting the orientation of the at least one virtual display screen may be generated such that the orientation of the at least one virtual display screen changes following the change of the direction of the user's line of sight.

In some embodiments, based on the projection position of the user's line of sight, the first instruction information for dynamically adjusting the position of the at least one virtual display screen in a horizontal direction and/or a vertical direction, respectively, may be generated.

If the application scenario information of the virtual display screen is the window interface information displayed by at least one virtual display screen of the virtual display screens, generating the first instruction information based on the application scenario information may include the following.

The window interface information displayed by the first virtual display screen of the at least one virtual display screen may be obtained. Based on the displayed window interface information, the first instruction information for adjusting the first virtual display screen to be a flat screen or a curved screen may be generated.

The first electronic device may be configured to obtain the display parameter corresponding to the at least one virtual display screen based on the first instruction information.

In Manner two: Based on the application scenario information, the display parameter for adjusting the virtual display screen in the first electronic device may be obtained. The display parameter may be sent to the first electronic device.

If the application scenario information of the virtual display screen is the user behavior information with respect to at least one virtual display screen of the virtual display screens, based on the application scenario information, obtaining the display parameter of the virtual display screen in the first electronic device may include the following.

In some embodiments, the display size corresponding to the at least one virtual display screen based on the distance change information of the user and the at least one virtual display screen and/or the bending form of the at least one virtual display screen may be obtained.

In some embodiments, the orientation of the at least one virtual display screen may be obtained based on the direction of the user's line of sight, such that the orientation of the at least one virtual display screen changes following the change of the direction of the user's line of sight.

In some embodiments, based on the projection position of the user's line of sight, the position of the at least one virtual display screen in a horizontal direction and/or the position in a vertical direction may be obtained, respectively.

If the application scenario information of the virtual display screen is the window interface information displayed in at least one virtual display screen of the virtual display screens, obtaining the display parameter for adjusting the virtual display screen in the first electronic device based on the application scenario information may include the following.

The window interface information displayed by the first virtual display screen of the at least one virtual display screen may be obtained. Based on the displayed window interface information, adjustment information of a flat screen or a curved screen corresponding to the first virtual display screen may be obtained.

In some embodiments, the display processing method implemented to the second electronic device may further include the following.

If the physical display screen is in a screen saver state or an off-screen state, second instruction information for configuring at least two virtual display screens in the first electronic device to be combined to form a combined display screen may be generated.

If the physical display screen is in an on-screen state, third instruction information for controlling the physical display screen of the first electronic device and the at least one virtual display screen to be combined to form a combined display screen may be generated.

After receiving the second instruction information by the first electronic device, a control instruction for controlling the at least two virtual display screens to be combined to form a combined display screen. In some embodiments, the second instruction information may be configured as a corresponding control instruction.

After receiving the third instruction information by the first electronic device, a control instruction for controlling the physical display screen of the first electronic device and the at least one virtual display screen to be combined to form a combined display screen. In some embodiments, the third instruction information may be configured as a corresponding control instruction.

In some embodiments, the display screen processing method implemented to the second electronic device may further include the following.

The combined display screen as an integrated display screen may be configured to display at least one window interface. In some embodiments, fourth instruction information for controlling the combined display screen as an integrated display screen to display at least one window interface may be generated.

If the physical display screen is in an on-screen state, and the physical display screen and the at least one virtual display screen are combined to form a combined display screen, the display screen processing method implemented to the second electronic device may further include the following.

If the physical display screen is a flat screen, fifth instruction information for adjusting the combined display screen as a flat screen may be generated.

If the physical display screen is a curved screen, sixth instruction information for adjusting the combined display screen as a curved screen may be generated.

After receiving the fifth instruction information by the first electronic device, a control instruction for controlling the combined display screen as a flat screen may be generated. In some embodiments, the fifth instruction information may be configured as a corresponding control instruction.

After receiving the sixth instruction information by the first electronic device, a control instruction for controlling the combined display screen as a curved screen may be generated. In some embodiments, the sixth instruction information may be configured as a corresponding control instruction.

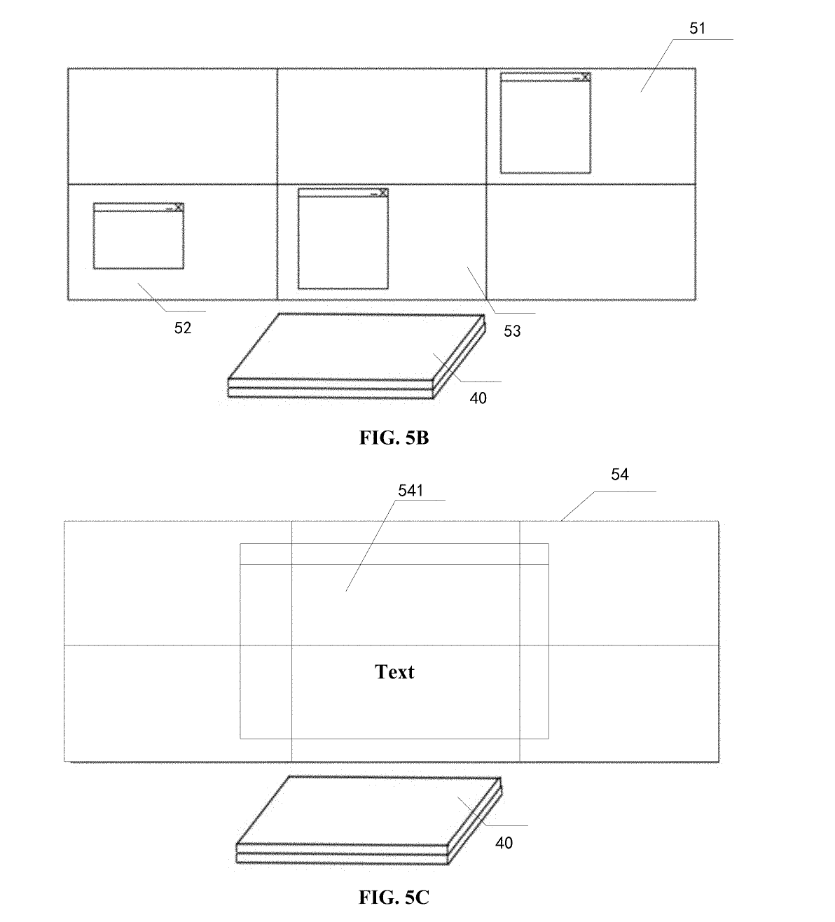

FIG. 7 is an internal structural diagram of a first electronic device according to some embodiments of the present disclosure. The first electronic device may include the following.

An optical lens module 71 may be configured to display a virtual display screen. A first acquiring module 72 may be configured to acquire application scenario information of the virtual display screen. A first adjusting module 73 may be configured to adjust display parameter of the virtual display screen based on the application scenario information.

In some embodiments, the first acquiring module 72 may include the following.

A first acquiring unit may be configured to acquire user behavior information with respect to at least one virtual display screen of the virtual display screens; and/or a second acquiring unit may be configured to acquire window interface information displayed by at least one virtual display screen of the virtual display screens.

In some embodiments, if the application scenario information of the virtual display screen is the user behavior information with respect to at least one virtual display screen of the virtual display screens, the first adjusting module 73 may include the following.

A first adjusting unit may be configured to adjust a display size of the at least one virtual display screen based on distance change information of the user and the at least one virtual display screen, and/or to dynamically adjust a bending form of the at least one virtual respectively.

A second adjusting unit may be configured to dynamically adjust an orientation of the at least one virtual display screen based on a direction of the user's line of sight, so that the orientation of the at least one virtual display screen changes following the change of the direction of the user's line of sight.

A third adjusting unit may be configured to dynamically adjust a position of the at least one virtual display screen in a horizontal direction and/or a vertical position direction based on a projection position of the user's line of sight.

In some embodiments, the first adjusting unit may include the following.

A first acquiring subunit may be configured to obtain at least one row of pixels from the virtual display screen for each virtual display screen, each row of pixels being parallel to a horizontal plane.

A first adjusting subunit may be configured to adjust a bending form of each row of pixels so that a distance between each pixel of the row and the user is respectively equal, thereby obtaining a corresponding bending form of the at least one row of pixels and achieving a corresponding bending form of the at least one virtual display screen.

In some embodiments, if the application scenario information of the virtual display screen as acquired is window interface information displayed by at least one virtual display screen of the virtual display screens, the first adjusting module 73 may include the following.

A second acquiring unit may be configured to acquire the window interface information displayed by the first virtual display screen of the at least one virtual display screen.

A fourth adjusting unit may be configured to adjust the first virtual display screen as a flat screen or a curved screen based on the displayed window interface information.

In some embodiments, displaying, by the first electronic device, a plurality of virtual display screens through the optical lens module may further include the following.

In some embodiments, a first combining module may be configured to combine at least two virtual display screens to form a combined display screen if the physical display screen is in a screen saver state or an off-screen state. In other embodiments, a second combining module may be configured to combine the physical display screen and the at least one virtual display screen to form a combined display screen if the physical display screen is in an on-screen state.

In some embodiments, the first electronic device may also include a controlling module that may be configured to control the combined display screen as an integrated display screen to display at least one window interface.

In some embodiments, if the physical display screen is in an on-screen state, combining the physical display screen and the at least one virtual display screen to form the combined display screen may include the following.

A second adjusting module may be configured to adjust the combined display screen as a flat screen if the physical display screen is a flat screen.

A third adjusting module may be configured to adjust the combined display screen as a curved screen if the physical display screen is a curved screen.

In some embodiments, the third adjusting module may include a determining unit that may be configured to determine a position of the physical display screen in the combined display screen if the physical display screen is a curved screen.

A fourth adjusting unit may be configured to adjust a bending form of the combined display screen based on a bending form of the physical display screen and the position of the physical display screen in the combined display screen.

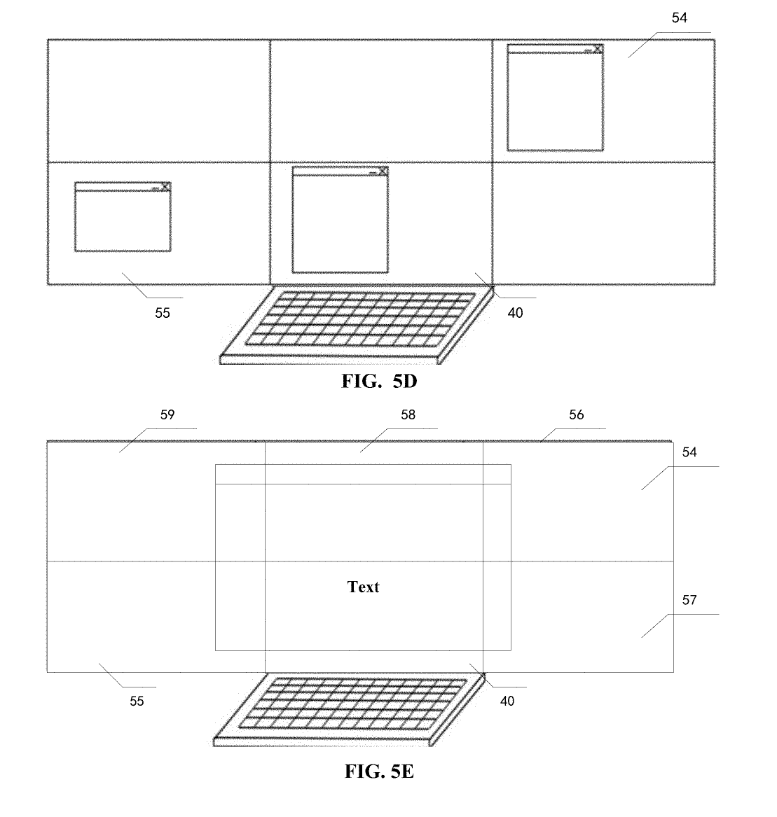

FIG. 8 is a structural diagram of a second electronic device according to some embodiments of the present disclosure. The second electronic device may include the following.

A physical display screen 40. A first acquiring module 81 may be configured to acquire the application scenario information of the virtual display screen displayed by the first electronic device through the optical lens module. The second electronic device may be connected with the first electronic device, and the second electronic device may have the physical display.

The first adjusting module 82 may be configured to adjust the display parameter(s) of the virtual display screen in the first electronic device based on the application scenario information.

In some embodiments, the application scenario information of the virtual display screen may include: the user behavior information with respect to at least one virtual display screen of the virtual display screens, and/or, the window interface information displayed by at least one virtual display screen of the virtual display screens.

In some embodiments, the first adjusting module 82 may include the following.

A first generating unit may be configured to generate the first instruction information based on the application scenario information; and a first sending unit may be configured to send the first instruction information to the first electronic device.

A second generating unit may be configured to obtain the display parameter(s) for adjusting the virtual display screen in the first electronic device based on the application scenario information; and a second sending unit may be configured to send the display parameter(s) to the first electronic device.

In some embodiments, if the application scenario of the virtual display screen is the user behavior information with respect to at least one virtual display screen of the virtual display screens, the first generating unit may include the following.

A first generating subunit may be configured to generate the display size for adjusting the at least one virtual display screen based on the distance change information of the user and the at least one virtual display screen, and/or the first instruction information for dynamically adjusting a bending form of at least one virtual display screen.

A second generating subunit may be configured to generate the first instruction information for dynamically adjusting an orientation of the at least one virtual display screen based on the direction of the user's line of sight, so that the orientation of the at least one virtual display screen changes following the direction of the user's line of sight.

A third generating subunit may be configured to generate the first instruction information for dynamically adjusting a position in a horizontal direction and/or a vertical direction of the at least one virtual display screen based on the projection position of the user's line of sight.

In some embodiments, if the application scenario information of the virtual display screen is the window interface information displayed by at least one virtual display screen of the virtual display screens, the first generating unit may include the following.

A first acquiring subunit may be configured to acquire the window interface information displayed by a first virtual display screen of the at least one virtual display screen.

A fourth generating subunit may be configured to generate, based on the displayed window interface information, the first instruction information for adjusting the first virtual display screen as a flat screen or a curved screen.

In some embodiments, if the application scenario information of the virtual display screen is the user behavior information with respect to at least one virtual display screen in the virtual display screens, the second generating unit may include the following.

A second acquiring subunit may be configured to obtain the display size corresponding to the at least one virtual display screen based on the distance change information of the user and the at least one virtual display screen, and/or obtain the bending form of the at least one virtual display screen.

A third acquiring subunit may be configured to obtain the orientation of the at least one virtual display screen based on the direction of the user's line of sight, so that the orientation of the at least one virtual display screen changes following the change of the direction of the user's line of sight.

A fourth acquiring subunit may be configured to obtain the position in a horizontal direction and/or in a vertical direction of the at least one virtual display screen respectively based on the projection position of the user's line of sight.

In some embodiments, if the application scenario information of the virtual display screen is the window interface information displayed by the at least one virtual display screen of the virtual display screens, the second generating unit may include the following.

A fifth acquiring subunit may be configured to acquire the window interface information displayed by a first virtual display screen of the at least one virtual display screen.

A sixth acquiring subunit may be configured to acquire the adjustment information of a flat screen or a curved screen corresponding to the first virtual display screen based on the displayed window interface information.

In some embodiments, the second electronic device may also include the following.

A first generating module may be configured to generate the second instruction information for controlling the at least two virtual display screens in the first electronic device to be combined to form a combined display screen if the physical display screen is in a screen saver state or an off-screen state.

A second generating module may be configured to generate the third instruction information for controlling the physical display screen of the first electronic device and the at least one virtual display screen to be combined to form a combined display screen if the physical display screen is in an on-screen state.

In some embodiments, the second electronic device may also include a controlling module that may be configured to control the combined display screen as a whole to display at least one window interface, or a third generating module that may be configured to generate the fourth instruction information for controlling the combined display screen as a whole to display the at least one window interface.

In some embodiments, if the physical display screen is in an on-screen state and the physical display screen and the at least one virtual display screen are combined to form a combined display screen, the second electronic device further may include the following.

A third generating module may be configured to generate the fifth instruction information for adjusting the combined display screen as a flat screen if the physical display screen is a flat screen.

A fourth generating module may be configured to generate the sixth instruction information for adjusting the combined display screen as a curved screen if the physical display screen is a curved screen.

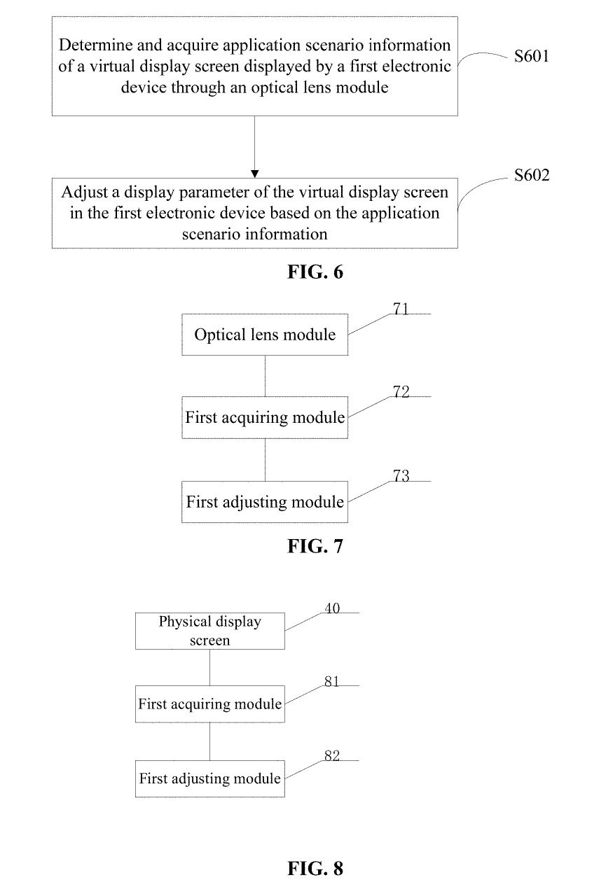

FIG. 9 is a structural diagram of another first electronic device according to some embodiments of the present disclosure. The first electronic device may include the following.

An optical lens module 90 may be configured to display one or more virtual display screens. A memory 91 may be configured to store a program. A processor 92 may be configured to execute the program, and the program is configured to perform the following operations.

The application scenario information of the virtual display screen may be obtained and determined. Based on the application scenario information, the display parameter(s) of the virtual display screen may be adjusted.

The first electronic device may also include a bus, a communication interface 93, an input device 94, and an output device 95. The optical lens module 90, the processor 92, the memory 91, the communication interface 93, the input device 94, and the output device 95 may be connected via a bus with each other.

The bus may include a pathway to transfer information between the various components of the computer system.

The processor 92 may be a general-purpose processor such as a general-purpose central processing unit (CPU), a network processor (NP), a microprocessor, or the like. It may also be an application-specific integrated circuit (ASIC), or one or more integrated circuits for controlling program execution of the inventive solution. It can also be a digital signal processor (DSP), an application specific integrated circuit (ASIC), an off-the-shelf programmable gate array (FPGA) or other programmable logic device, a discrete gate or transistor logic device, a discrete hardware component.

The processor 92 may include a main processor, and/or may also include a baseband chip, a modem, and the like. The memory 91 may store the program for executing the technical solutions of the present disclosure and may also store an operating system and other services. In some embodiments, the program may include program codes with computer operation instructions. In some embodiments, the memory 91 may include a read-only memory (ROM), other types of static storage devices that can store static information and instructions, random access memory (RAM), storable information, and other types of instructions for dynamic storage devices, disk storage, flash, and the like.

The input device 94 may include means for receiving data and information entered by the user, such as a keyboard, a mouse, a camera, a scanner, a light pen, a voice input device, a touch screen, a pedometer, a gravity sensor, or the like.

The output device 95 may include devices that allow output information to the user, such as a display screen, a printer, a speaker, or the like. The communication interface 93 may include devices using any type of transceiver to communicate with other devices or communication networks, such as Ethernet, Radio Access Network (RAN), Wireless Local Area Network (WLAN), or the like.

The processor 92 may be configured to execute the program stored in the memory 91 and instruct other devices and may be configured to implement various manners in the method provided by the embodiments of the present disclosure.

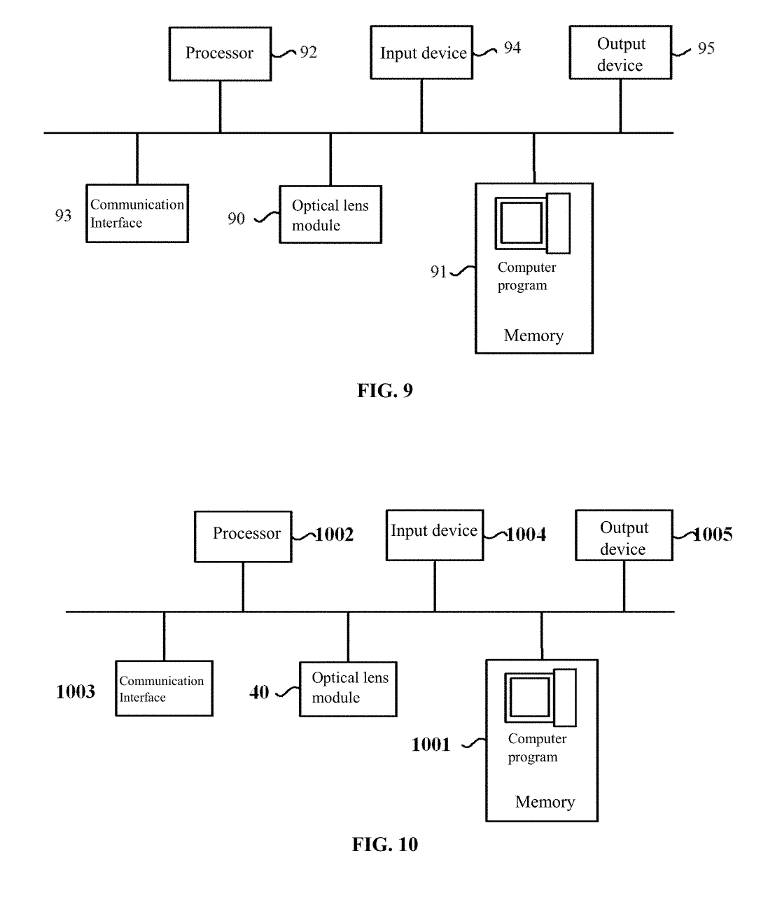

FIG. 10 shows is a structural diagram of another second electronic device according to some embodiments of the present disclosure, the second electronic device may include the following.

A physical display screen 40. A memory 1001 may be configured to store a program. A processor 1002 may be configured to execute the program, and the program is configured to perform the following operations.

The application scenario information of one or more virtual display screens displayed by the first electronic device through the optical lens module may be acquired. The second electronic device may be connected with the first electronic device. Based on the application scenario information, the display parameter(s) of the virtual display screen in the first electronic device may be adjusted.

The second electronic device may further include a bus, a communication interface 1003, an input device 1004, and an output device 1005. The physical display screen 40, the processor 1002, the memory 1001, the communication interface 1003, the input device 1004, and the output device 1005 may be connected via a bus.

An embodiment of the present disclosure further provides a storable medium on which a computer program is stored. When the computer program is executed by a processor, the steps of the display processing method implemented to the first electronic device as described in any of the foregoing embodiments are realized.

An embodiment of the present disclosure may further provide a storable medium on which a computer program is stored. When the computer program is executed by a processor, the steps of the display processing method implemented to the second electronic device as described in any of the foregoing embodiments are realized.

It should also be noted that in the present disclosure, relational terms such as first and second, etc., are only used to distinguish one entity or an operation from another entity or another operation, and do not necessarily require or imply that there is any such actual relationship or order between the entities or the operations. Moreover, the terms “comprise”, “comprise” or any other variation thereof are intended to cover a non-exclusive inclusion, such that a process, a method, an article, or a device that comprises a list of elements includes not only those elements but also may include those that are not explicitly listed. Other elements may also include elements inherently to such a process, a method, an article, or a device. In the case of no more limitation, the element defined by the sentence “include one” does not exclude that there is another same element in the process, the method, the article, or the device including the element.

Each embodiment in this specification is described in a progressive manner, and each embodiment focuses on the differences from other embodiments. The same or similar parts among the embodiments may be referred to each other.

Various modifications to the above-described embodiments are readily apparent to a person skilled in the art, and the general principles defined herein may be applied to other embodiments not described herein, without departing from the spirit or scope of the present application. Therefore, the present application is not limited to the examples shown herein, but it should conform to the widest scope consistent with the principles and novel features disclosed herein.

What is claimed is:

1. A display screen processing method, comprising:
determining application scenario information of one or more virtual display screens displayed by a first electronic device, the first electronic device being coupled with a second electronic device that includes a physical display screen; and
adjusting a display parameter of the one or more virtual display screens based on the application scenario information, the one or more virtual display screens being configured to display one or more interfaces of the physical display screen.

2. The method of claim 1, wherein determining the application scenario information of the one or more virtual display screens includes:
determining user behavior information with respect to at least one of the one or more virtual display screens.

3. The method of claim 1, wherein determining the application scenario information of the one or more virtual display screens includes:
determining window interface information displayed by at least one of the one or more virtual display screens.

4. The method of claim 2, wherein adjusting the display parameter of the one or more virtual display screens based on the application scenario information includes:
adjusting at least one of a display size or a bending form of the at least one virtual display screen based on a distance change information of a user and the at least one virtual display screen.

5. The method of claim 2, wherein adjusting the display parameter of the one or more virtual display screens based on the application scenario information includes:
adjusting an orientation of the at least one virtual display screen based on a direction of the user's line of sight such that the orientation of the at least one virtual display screen changes following a change of the direction of the user's line of sight.

6. The method of claim 2, wherein adjusting the display parameter of the one or more virtual display screens based on the application scenario information includes:
adjusting a position of the at least one virtual display screen in at least one of a horizontal direction or a vertical direction.

7. The method of claim 4, wherein: adjusting the bending form of the at least one virtual display screen based on the distance change information of the user and the at least one virtual display screen includes:
obtaining at least one row of pixels from each of the at least one virtual display screen, each row of pixels being parallel to a horizontal plane; and
adjusting a bending form of each row of pixels such that a distance between each pixel of the row and the user is respectively equal, thereby obtaining the bending form of the at least one virtual display screen.

8. The method of claim 3, wherein adjusting the display parameter of the one or more virtual display screens based on the application scenario information includes:
acquiring the window interface information displayed by a first virtual display screen of the at least one virtual display screen; and
based on the displayed window interface information, adjusting the first virtual display screen as a flat screen or a curved screen.

9. The method of claim of claim 1, wherein the one or more virtual display screens include a plurality of virtual display screens, and the method further comprises one of:
combining at least two of the plurality of virtual display screens to form a combined display screen upon determining that the physical display screen is in a screen saver state or an off-screen state; and
combining the physical display screen and at least one of the plurality of virtual display screens to form a combined display screen upon determining that the physical display screen is in an on-screen state.

10. The method of claim 9, further comprises:
controlling the combined display screen as a whole to display at least one window interface; and
after determining that the physical display screen is in the on-screen state, combining the physical display screen and the at least one virtual display screen to form the combined display screen by:
after determining that the physical display screen is a flat screen, adjusting the combined display screen as a flat screen; and
after determining that the physical display screen is a curved screen, adjusting the combined display screen as a curved screen.

11. The method of claim 10, wherein adjusting the combined display screen as the curved screen includes:
after determining that the physical display screen is the curved screen, determining a position of the physical display screen in the combined display screen; and
adjusting a bending form of the combined display screen based on a bending form of the physical display screen and the position of the physical display screen in the combined display screen.

12. The method of claim 2, further comprising:
identifying a virtual display screen where a focus position corresponding to a direction of a user's line of sight is located; and
determining the virtual display screen as the at least one of the one or more virtual display screens.

13. The method of claim 2, further comprising: acquiring information of squinting or blinking of a user as the user behavior information.

14. The method of claim 5, further comprising:
emitting light to illuminate the user's eyes;
detecting, by a sensor equipped to the first electronic device, light reflected by the user's eyes to determine positions of the user's eye; and
determining the direction of the user's line of sight according to the positions of the user's eyes.

15. The method of claim 5, further comprising:
tracking head movement of the user; and
determining the direction of the user's line of sight according to the head movement of the user.

16. A display system, comprising:
a first electronic device coupled with a second electronic device that has a physical display screen, wherein the first electronic device includes:
an optical lens module configured to display one or more virtual display screens; and
a processor configured to determine application scenario information of the one or more virtual display screens; and adjust a display parameter of the one or more virtual display screens based on the application scenario information, the one or more virtual display screens being configured to display one or more interfaces of the physical display screen.

17. The display system of claim 16, wherein the processor is further configured to determine user behavior information with respect to at least one of the one or more virtual display screens.

18. The display system of claim 16, wherein the processor is further configured to determine window interface information displayed by at least one of the one or more virtual display screens.
